(19) United States
(12) Patent Application Publication
(10) Pub. No.: US 2006/0148471 A1
(43) Pub. Date: Jul. 6, 2006

(54) Method for connecting to a wireless network by synchronization and a device thereof

(75) Inventor: Hsiao-Shun Jan, Taipei Hsien (TW)

Correspondence Address: TROXELL LAW OFFICE PLLC;SUITE 1404, 5205 LEESBURG PIKE, FALLS CHURCH, VA, 22041, US

(73) Assignee: Z-Com, Inc.

(21) Appl. No.: 11/028,569

(22) Filed: Jan. 5, 2005

(51) Int. Cl. H04M 1/00

(52) U.S. Cl. 455/434

(57) ABSTRACT

A method for connecting to a wireless network by synchronization and a device thereof overcomes the inconveniences implicit in the method and procedure of connecting to a wireless network by synchronization of the prior art. The device for connecting to a wireless network by synchronization is comprised of: a radio frequency unit; a digital signal processing unit electrically connected to the radio frequency unit; a micro-processing unit electrically connected to the digital signal processing unit; a memory unit electrically connected to the micro-processing unit; an interface unit electrically connected to the micro-processing unit; a switch unit electrically connected to the micro-processing unit. After the device for connecting to a wireless network by synchronization has scanned the appropriate frequency bands by programming, it automatically connects to a wireless network by synchronization.

### BACKGROUND OF THE INVENTION

1. Field of the Invention

The present invention relates to a method for connecting to a wireless network by synchronization and a device thereof and, more particularly, to an architecture and concept for connecting to a wireless network with automatic synchronization.

2. Description of Related Art

As the Internet has evolved it has grown to play a larger and larger role in most people's lives. There are many methods and devices for connecting with the Internet, and these devices play a key role in how a user experiences the Internet. Due to breakthroughs in the technology involved in wireless communication networks and the declining price of their related communication products, wireless network devices are steadily replacing prior network devices bit by bit. Therefore, the procedure of the prior art by which a user connected to the Internet was complex and difficult, especially for users who lacked technical knowledge.

The method of connecting to a wireless network with synchronization in the prior art was achieved by using a driver or an installation program provided from the wireless network device. Then users performed the setup and installation of the device of the wireless network. However, as users themselves are not necessarily experts in computer science or telecommunication, such connecting procedures are inconvenient and difficult for many people who wish to use wireless technology. Some software companies such as Microsoft for example, provide a built-in-driver program for users, but, even then, it is difficult to provide a solution for the range of problems that users may encounter.

A summary of the drawbacks of the wireless network connecting by synchronization in the prior art is as following.

1. It is necessary for a user to install the provided driver for connecting to the wireless network from the firm of the wireless network device or to setup the provided built-in-driver from the firm of the software company by themselves.

2. If a user has lost the provided driver for connecting to the network from the firm of the wireless network device or the provided built-in-driver from the firm of the software company, it compounds their inconvenience and necessitates them finding the driver from somewhere.

3. faced with these problems, many users will be deterred from using the method of connecting to a wireless network of the prior art, particularly those who are lacking in the necessary technical knowledge.

Accordingly, the conventional method of connecting to a wireless network by synchronization and a device thereof is inconvenient and has several practical drawbacks. The present invention aims to solve the above problems of the prior art.

### SUMMARY OF THE INVENTION

The main objective of the present invention is to overcome the inconveniences of the method and procedure for connecting to a wireless network by synchronization of the prior art.

To solve the above objective, the present invention provides a device for connecting to a wireless network by synchronization, which comprises: a radio frequency (RF) unit, for transmitting and receiving a signal, along with amplifying/reducing the signal, filtering, and synthesizing; a digital signal processing unit, electrically connected to the radio frequency unit, for processing the digital signal; a micro-processing unit, electrically connected to the digital signal processing unit, for performing communication protocols and logic operations; a memory unit, electrically connected to the micro-processing unit, for accessing the signal; an interface unit, electrically connected to the micro-processing unit, for managing the interface of input/output signals; and a switch unit, electrically connected to the micro-processing unit, for generating a trigger signal, wherein the switch unit comprises a switch outside trigger unit and a switch inside current unit, the switch outside trigger unit is disposed in an easily seen manner on the the device for connecting to a wireless network by synchronization, and the switch inside current unit is electrically connected to the micro-processing unit.

The present invention provides a method for connecting to a wireless network by synchronization, the method comprising the steps of: triggering a net on-line switch of the device for connecting to a wireless network; scanning for other devices for connecting to a wireless network near the device for connecting to a wireless network; thereafter the device for connecting to a wireless network elects a frequency band for a wireless connection; receiving a signal transmitted from another device for connecting to a wireless network near the device for connecting to a wireless network; accordingly the device for connecting to a wireless network simulates collaboration and processes by synchronization between the signals; restarting the device for connecting to a wireless network; finally performing wireless connecting and message switching.

The method for wireless network connecting by synchronization and device thereof is the main objective of the present invention, it promotes a convenient and easy method for wirelessly connecting to the Internet. The various objectives and advantages of the present invention will be more readily understood from the following detailed description when read in conjunction with the appended drawing, in which:

### BRIEF DESCRIPTION OF THE DRAWINGS

FIG. 1 is a circuit block diagram of the device for connecting to a wireless network by synchronization of the present invention;

FIG. 2 is a flowchart of the method for connecting to a wireless network by synchronization of the present invention; and

FIG. 3 is an architectural diagram of the device for connecting to a wireless network accessing by synchronization of the present invention.

### DETAILED DESCRIPTION OF THE PREFERRED EMBODIMENTS

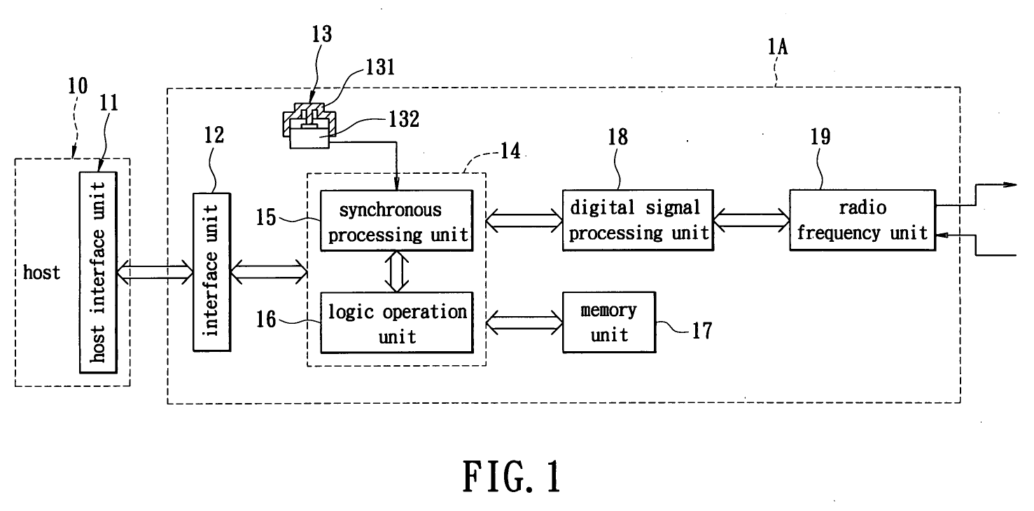

FIG. 1 shows a circuit block diagram of a device for connecting to a wireless network by synchronization of the present invention. The most important difference between the present invention and the prior art is the provision of a switch unit 13 in the present invention. A connection to wireless network can be established by simply triggering the switch unit 13 of a device 1A for connecting to a wireless network by synchronization of the present invention without requiring users to install a driver by themselves as in the prior art.

Please refer to FIG. 1. The device for connecting to a wireless network by synchronization 1A, comprises a radio frequency (RF) unit 19, for transmitting and receiving a signal, along with amplifying/reducing the signal, filtering, and synthesizing; an digital signal processing unit 18, for processing the digital signal; a micro-processing unit 14, for performing communication protocols and logic operations; a memory unit 17, for accessing the signal; an interface unit 12 for managing the interface of input/output signals; and a switch unit 13, for generating a trigger signal.

Please refer to FIG. 1. The digital signal processing unit 18 is electrically connected to the radio frequency unit 19; the micro-processing unit 14 is electrically connected to the digital signal processing unit 18; the memory unit 17 is electrically connected to the micro-processing unit 14; the interface unit 12 is electrically connected to the micro-processing unit 14; the switch unit 13 comprising of a switch outside trigger unit 131 and a switch inside current unit 132, the switch outside trigger unit 131 is disposed on an easily seen device 1A for connecting to a wireless network by synchronization, and the switch inside current unit 132 is electrically connected to the micro-processing unit 14.

Please refer to FIG. 1. The operation principle of the device 1A of the present invention is described as following: after users touch the switch inside current unit 132 of the switch unit 13, the switch inside current unit 132 generates a triggering signal to the micro-processing unit 14 and performs a communication protocol and logic operation. Wherein the micro-processing unit 14 comprises a logic operation unit 16 for performing logical algorithms and a synchronous processing unit 15, for performing synchronizing processes between the signals, electrically connected to the logic operation unit 16 and the switch inside current unit 132. The micro-processing unit 14 can be a central processor, a microprocessor or a micro-controller. To facilitate ease of commercial design and consumer use, the switch unit 13 can be a push-pull switch, a rocker switch, a rotary switch or a button switch.

Moreover, the memory unit 17 is electrically connected to the micro-processing unit 14, and the memory unit 17 accesses the related data message within a logical operation. The digital signal processing unit 18 is electrically connected the micro-processing unit 14 and the radio frequency unit 19. The digital signal-processing unit 18 negotiates the program of digital signal processes between the micro-processing unit 14 and the radio frequency unit 19. Then the radio frequency unit 19 transmits or receives a signal to amplify/reduce, filter or synthesize. Finally the micro-processing unit 14 is electrically connected to the interface unit 12. The micro-processing unit 14 communicates with a host 10 through a host interface unit 11 after the interface unit 12 executes I/O signal management. Moreover the memory unit 17 can be a volatile memory or nonvolatile memory, the digital signal processing unit 18 can be a digital signal processor, and the radio frequency unit 19 can be a radio frequency IC.

Please refer to FIG. 1, which is a flowchart for a method for connecting to a wireless network by synchronization according to the present invention. The method is finished by programming. The method comprises of the following steps: triggering a net on-line switch of the device for connecting to a wireless network (Step 200); scanning for other devices for connecting to a wireless network near the device for connecting to a wireless network (Step 201); thereafter electing a frequency band for a wireless connection for the device for connecting to a wireless network (Step 202); receiving a signal transmitted from the other device for connecting to a wireless network near the device for connecting to a wireless network (Step 203); simulating collaboration and process by synchronization between the signals for the device for connecting to a wireless network (Step 204); restarting the device for connecting to a wireless network (Step 205); and finally performing wireless connecting and message switching (Step 206), wherein the device is a system device with a connection to a wireless network; and the net on-line switch is disposed in an easily seen manner on the device.

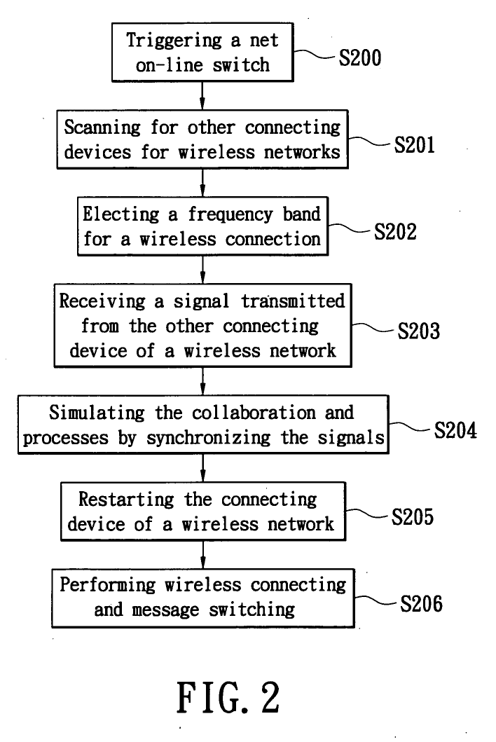

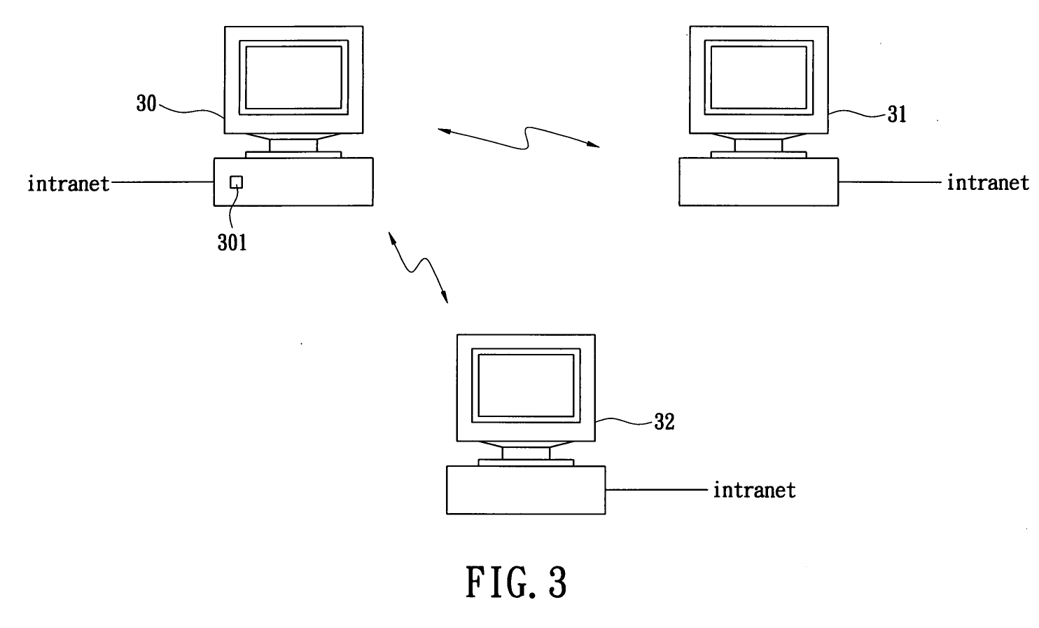

Please refer to FIGS. 1, 2 and 3, wherein FIG. 3 is an architectural diagram of a device for connecting to a wireless network by synchronization of the present invention. After triggering the on-line switch 301 of the device 1A of the present invention of the first wireless network device 30 (The on-line switch 301 in FIG. 3 is the switch unit 13 in FIG. 11), the first wireless network device 30 starts scanning the second wireless network device 31 and the third wireless network device 32 that is located near the first wireless network device 30, in other words it performs one to many signal scanning (Step 201). Wherein, if the first wireless network device 30 doesn't scan any radio data from the second wireless network device 31 or the third wireless network device 32, thereupon it stops performing all steps of the method of the present invention, and the first wireless network device 30 perform wireless connecting by others method for connecting to a wireless network. The first wireless network device 30 transmits radio data after it has finished connecting.

Accordingly, on electing a frequency band for wireless connection (Step 202), it elects a frequency band randomly or a frequency band having less noise. Whereupon the first wireless network device 30 receives a signal transmitted from the second wireless network device 31 and the third wireless network 32 that has the same frequency band as the first wireless network device 30 (if it receives a signal transmitted from the second wireless network device 31). After checking the band frequency and the second wireless network device 31 for connecting, it simulates collaboration and processes by synchronization between each of the signals, further performing signal processing with encryption or decryption.

After finishing the foregoing step, the first wireless network device 30 automatically executes the restart, finally performing wireless connecting and message switching between the first wireless network device 30 and the second wireless network device 31, so that the first wireless network device 30 is connected to the Internet.

The method for wireless network connecting by synchronization and a device of the present invention not only promotes a convenient and easy method and procedure for wireless connecting, but also includes many other advantages such as:

1. By changing the program of the present invention, the functions are more variable.

2. By expanding the program of the present invention, thereafter the functions are expandable.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A method for connecting to a wireless network by synchronization, the method comprising of the following steps:
triggering a net on-line switch of a device for connecting to a wireless network;
scanning for other devices for connecting to a wireless network;
electing a frequency band for a wireless connection;
receiving a signal transmitted from the other device for connecting to a wireless network;
simulating collaboration and processes by synchronizing the signals;
restarting said device for connecting to a wireless network; and
performing wireless connecting and message switching,
wherein said device is a system device with a connection to a wireless network; and said net on-line switch is disposed in an easily seen manner on said device.

2. The method for connecting to a wireless network by synchronization as claimed in claim 1, wherein in said step of scanning for other devices for connecting to a wireless network, if it picks up any radio data from another devices for connecting to a wireless network, it will perform the next step; if it doesn't scan any radio data from the other devices for connecting to a wireless network, it will stop performing all steps in claim 1, and said device will perform wireless connecting by other methods for connecting to a wireless network, finally said device will transmit some radio data after it have finished connecting.

3. The method for connecting to a wireless network by synchronization as claimed in claim 1, wherein in said step of scanning for other devices for connecting to a wireless network, one to many signal scans are performed.

4. The method for connecting to a wireless network by synchronization as claimed in claim 1, wherein in said step of electing a frequency band for a wireless connection, a frequency band is randomly elected.

5. The method for connecting to a wireless network by synchronization as claimed in claim 1, wherein in said step of electing a frequency band for a wireless connection, a frequency band having less noise is elected.

6. The method for connecting to a wireless network by synchronization as claimed in claim 1, wherein in said step of simulating collaboration and processes by synchronizing between the signals further comprises performing signal processes with encryption or decryption.

7. The method for connecting to a wireless network by synchronization as claimed in claim 1, wherein in said step of restarting said device for connecting to a wireless network, the device is automatically restarted.

8. The method for connecting to a wireless network by synchronization as claimed in claim 1, wherein in said step of performing wireless connecting and message switching occurs simultaneously.

9. A device for connecting to a wireless network by synchronization, comprising:
a radio frequency (RF) unit, for transmitting and receiving a signal, along with amplifying/reducing the signal, filtering, and synthesizing;
an digital signal processing unit, electrically connected to said radio frequency unit, for processing digital signals;
a micro-processing unit, electrically connected to said digital signal processing unit, for performing communication protocols and logic operations;
a memory unit, electrically connected to said micro-processing unit, for accessing the signal;
an interface unit, electrically connected to said micro-processing unit, for managing the interface of input/output signals; and
a switch unit, electrically connected to said micro-processing unit, for generating a trigger signal,
whereby said switch unit comprises a switch outside trigger unit and a switch inside current unit, said switch outside trigger unit is disposed on an easily seen device for connecting to a wireless network by synchronization, and said switch inside current unit is electrically connected to said micro-processing unit.

10. The device for connecting to a wireless network by synchronization as claimed in claim 9, wherein said radio frequency unit is a radio frequency IC.

11. The device for connecting to a wireless network by synchronization as claimed in claim 9, wherein said digital signal processing unit is a digital signal processor.

12. The device for connecting to a wireless network by synchronization as claimed in claim 9, wherein said micro-processing unit comprises:
a logic operation unit, for performing logical algorithms; and
a synchronous processing unit, electrically connected to said logic operation unit and said switch unit, for performing synchronous processes between the signals.

13. The device for connecting to a wireless network by synchronization as claimed in claim 9, wherein said micro-processing unit is a central processor.

14. The device for connecting to a wireless network by synchronization as claimed in claim 9, wherein said micro-processing unit is a microprocessor.

15. The device for connecting to a wireless network by synchronization as claimed in claim 9, wherein said micro-processing unit is a micro-controller.

16. The device for connecting to a wireless network by synchronization as claimed in claim 9, wherein said memory unit is a volatile memory or non-volatile memory.

17. The device for connecting to a wireless network by synchronization as claimed in claim 9, wherein said switch unit is a push-pull switch.

18. The device for connecting to a wireless network by synchronization as claimed in claim 9, wherein said switch unit is a rocker switch.

19. The device for connecting to a wireless network by synchronization as claimed in claim 9, wherein said switch unit is a rotary switch.

20. The device for connecting to a wireless network by synchronization as claimed in claim 9, wherein said switch unit is a button switch.
